(19) United States
(12) Patent Application Publication
(10) Pub. No.: US 2010/0077614 A1
(43) Pub. Date: Apr. 1, 2010

(54) METHOD FOR MANUFACTURING A WICK STRUCTURE OF A PLATE-TYPE HEAT PIPE

(75) Inventor: CHUEN-SHU HOU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXCONN TECHNOLOGY CO., LTD., Tu-Cheng (TW)

(21) Appl. No.: 12/238,446

(22) Filed: Sep. 26, 2008

(51) Int. Cl. B23P 15/26

(52) U.S. Cl. 29/890.032

(57) ABSTRACT

A method for manufacturing a wick structure of a plate-type heat pipe involves providing a base plate with a heat absorbing plate and two extending plates extending from opposite ends, providing a mold covering the base plate and with a first engaging portion corresponding to the heat absorbing plate and two second engaging portions corresponding to the extending plates, and filling metal powder into a gap between the mold and the base plate. The metal powder is heated to obtain a wick structure having one part adhered to a top surface of the heat absorbing plate and two other parts adhered to top surfaces of the extending plates of the base plate. The part of the wick structure adhered to a top surface of the heat absorbing plate has a thickness smaller than that of the other parts.

### BACKGROUND OF THE INVENTION

1. Field of the Invention

The disclosure relates to heat dissipation, and more particularly to a method for manufacturing a wick structure for a plate-type heat pipe.

2. Description of Related Art

Generally, plate-type heat pipes efficiently dissipate heat from heat-generating components such as central processing units (CPU). Referring to FIGS. 11-12, a conventional plate-type heat pipe comprises a top plate 100, a base plate 101 engaging the top plate 100, and a wick structure of uniform thickness 102 mounted on the base plate 101. A heat absorbing portion 103 extends downwardly from a center portion of the base plate 101, contacting the heat-generating components. When heat from a component enters the plate-type heat pipe via its heat absorbing portion 103, working fluid in the wick structure 102 absorbs the heat and vaporizes. If the wick structure 102 is too thick, the vapor remains therein, increasing heat resistance of the heat pipe and raising a temperature of the base plate 101, possibly inflicting damage thereon. If the wick structure 102 is too thin, the working fluid vaporizes too quickly, damaging the wick structure 102.

It is therefore desirable to provide a method for manufacturing a wick structure of a plate-type heat pipe of sufficient thickness to engage the plate-type heat pipe.

### SUMMARY OF THE INVENTION

A method for manufacturing a wick structure of a plate-type heat pipe comprises providing a base plate including an elongated heat absorbing plate and two extending plates angling upwardly from opposite ends of the heat absorbing plate, providing a quantity of metal powder, providing a mold covering the base plate and comprising a first engaging portion corresponding to the heat absorbing plate of the base plate with two second engaging portions angling upwardly from opposite ends of the first engaging portion and corresponding to the extending plates of the base plate with the mold and the base plate mutually defining a space therebetween, filling the metal powder into the space, heating the metal powder to obtain a wick structure including a first adhering portion securely fixed to a top surface of the heat absorbing plate of the base plate, and two second adhering portions angling from opposite ends of the first adhering portion and securely fixed to top surfaces of the extending plates of the base plate. The first adhering portion is thinner than the second adhering portion.

Other advantages and novel features will become more apparent from the following detailed description of preferred embodiments when taken in conjunction with the accompanying drawings.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a cross-section of a base plate of a plate-type heat pipe in accordance with a first embodiment of the disclosure and a mold.

FIG. 2 is a cross-section of the base plate of the plate-type heat pipe of FIG. 1 engaging a wick structure.

FIG. 3 is a cross-section of a base plate of a plate-type heat pipe in accordance with a second embodiment of the disclosure and a mold.

FIG. 4 is a cross-section of the base plate of the plate-type heat pipe of FIG. 3 engaging a wick structure.

FIG. 5 is a cross-section of a base plate of a plate-type heat pipe in accordance with a third embodiment of the disclosure and a mold.

FIG. 6 is a cross-section of the base plate of the plate-type heat pipe of FIG. 5 engaging a wick structure.

FIG. 7 is a cross-section of a base plate of a plate-type heat pipe in accordance with a fourth embodiment of the disclosure and a mold.

FIG. 8 is a cross-section of the base plate of the plate-type heat pipe of FIG. 7 engaging a wick structure.

FIG. 9 is a cross-section of a base plate of a plate-type heat pipe in accordance with a fifth embodiment of the disclosure and a mold.

FIG. 10 is a cross-section of the base plate of the plate-type heat pipe of FIG. 9 engaging a wick structure.

FIG. 11 is an exploded, cross-section of a related plate-type heat pipe.

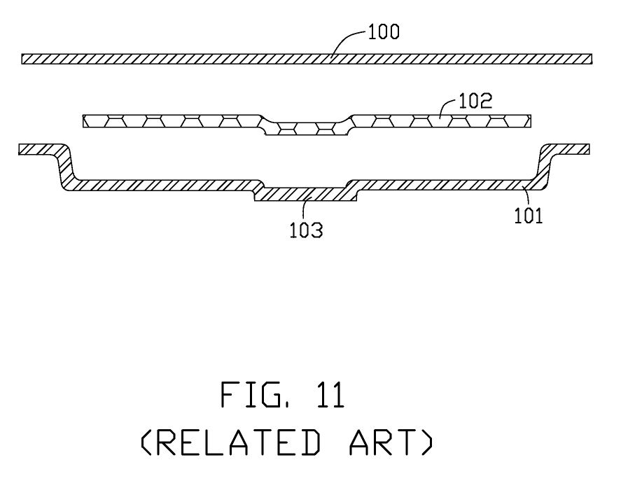

FIG. 12 is an assembled view of FIG. 11.

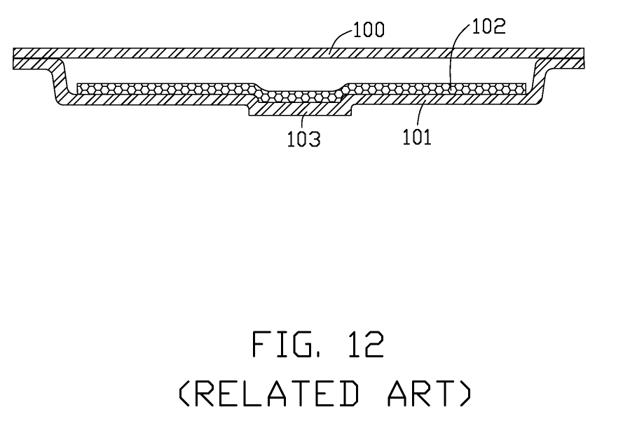

### DETAILED DESCRIPTION OF THE INVENTION

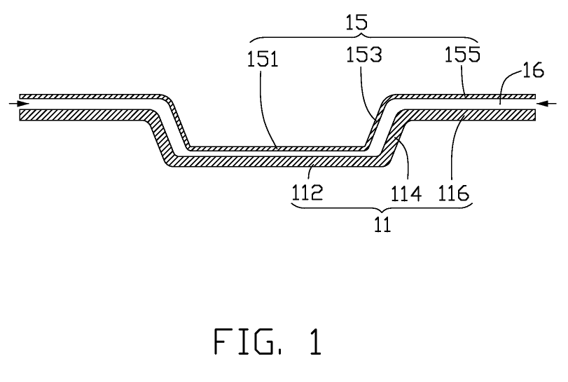

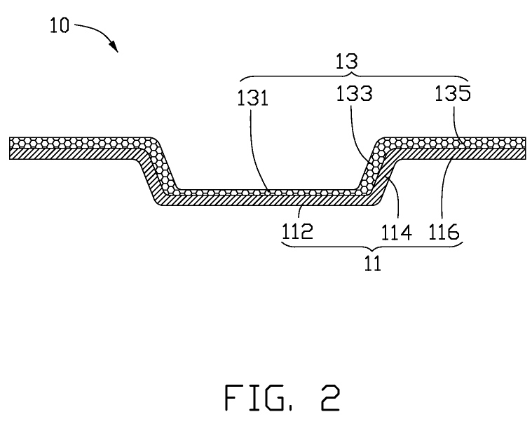

Referring to FIGS. 1-2, a method for manufacturing a wick structure 13 of a plate-type heat pipe 10 in accordance with a first embodiment comprises providing a bend base plate 11 including an elongated heat absorbing plate 112, a pair of extending plates 114 angling upwardly from opposite ends of the heat absorbing plate 112, and two engaging plates 116 extending outwardly from ends of the extending plates 114 respectively and facing apart, providing a quantity of metal powder, and providing a mold 15. The mold 15 has a profile matching that of the base plate 11. The mold includes an elongated first engaging portion 151 corresponding to the heat absorbing plate 112 of the base plate 11, two second engaging portions 153 angling outwardly from opposite ends of the first engaging portion 151 and corresponding to the extending plates 114 of the base plate 11, and two third engaging portions 155 extending outwardly from ends of the second engaging portions 153 corresponding to the engaging plates 116 of the base plate 11. The first, second and third engaging portions 151, 153, 155 connect with each other in series. The mold 15 covers a top of the base plate 11, thereby defining a space 16 therebetween. The metal powder is then filled into the space 16 and heated at a high temperature to obtain a sintered wick structure 13 including a first adhering portion 131 securely fixed to a top surface of the heat absorbing plate 112 of the base plate 11, two second adhering portions 133 securely fixed to top surfaces of the extending plates 114 of the base plate 11, and two third adhering portions 135 securely fixed to top surfaces of the engaging plates 116 of the base 11.

In this embodiment, the space between the second engaging portion 153 and the extending plate 114 of the base plate 11 equals that between the third engaging portion 155 and the engaging plate 116 of the base plate 11 and exceeds that between the first engaging portion 151 and the heat absorbing plate 112 of the base plate 11. Thus, thickness of the second adhering portion 133 equals that of the third adhering portion 135 and exceeds that of the first adhering portion 131 of the wick structure 13. When generated heat enters the plate-type heat pipe 10 via heat absorbing portion 112, working fluid contained in the first adhering portion 131 of the wick structure 13 absorbs the heat and vaporizes, and working fluid contained in the second and third adhering portions 133, 135 of the wick structure 13 flows to the first adhering portion 131, enhancing heat dissipation.

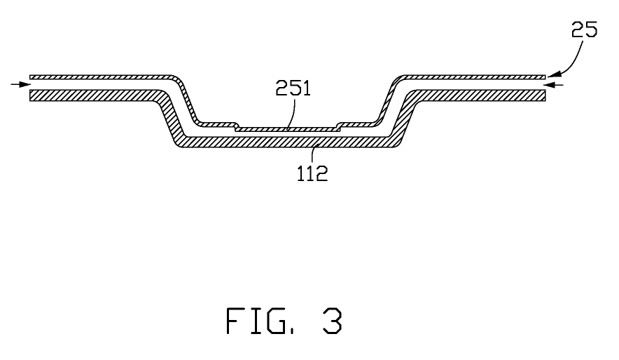

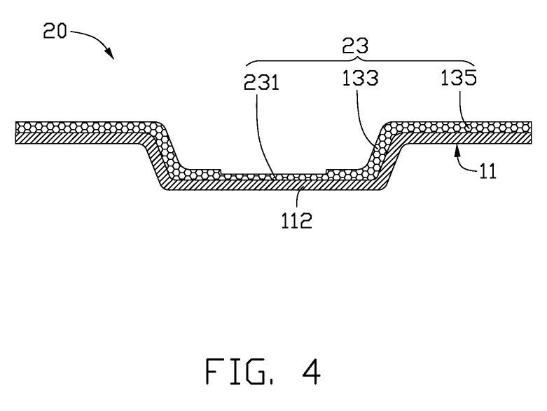

Referring to FIGS. 3 and 4, a method for manufacturing a wick structure 23 of a plate-type heat pipe 20 in accordance with a second embodiment of the disclosure differs only from the first embodiment in the first engaging portion 251 of mold 25, a center portion thereof being elongated with the depth of the gap between the center portion of the first engaging portion 251 and the heat absorbing plate 112 of the base plate 11 being less than that between opposite portions and the heat absorbing plate 112. Thus, a first adhering portion 231 of the wick structure 23 formed by metal powder received in the first engaging portion 251 of the mold 25 has a stepped configuration. A center portion of the first adhering portion 231 is thinner than the opposite portions. When generated heat enters the plate-type heat pipe 10 via a center portion of the heat absorbing portion 112, working fluid contained in the center portion of the first adhering portion 231 of the wick structure 23 absorbs the heat and vaporizes, and working fluid in the other portion of the first adhering portion 231 and the second and third adhering portions 133, 135 of the wick structure 23 flows to the center portion of the first adhering portion 231.

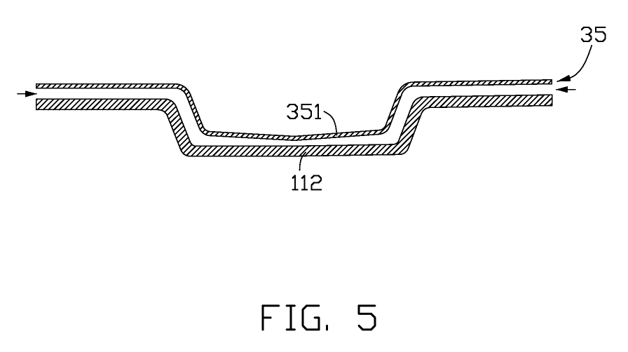

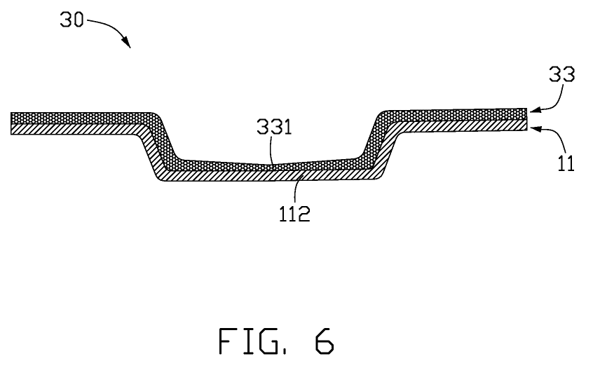

Referring to FIGS. 5 and 6, a method for manufacturing a wick structure 33 of a plate-type heat pipe 30 in accordance with a third embodiment of the disclosure differs only from the first embodiment in that a first engaging portion 351 of a mold 35 includes two symmetrical parts with a depth of a gap between the engaging portion 351 and the heat absorbing plate 112 of the base plate 11 being increased from a center where the two symmetrical parts join toward opposite ends of the two symmetrical parts. As a result, the first adhering portion 331 of the wick structure 33 includes two symmetrical trapezoids with thickness of the first adhering portion 331 increasing from a center to distal ends. A center of the first adhering portion 331 securely adheres to a center portion of the heat absorbing plate 112 of the base plate 11.

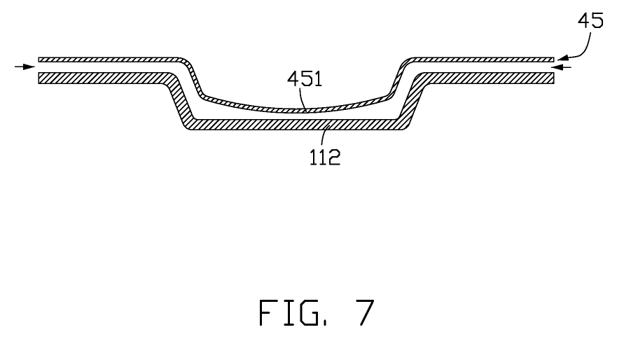

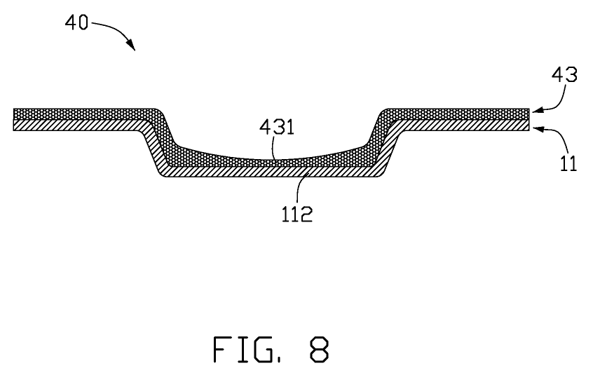

Referring to FIGS. 7 and 8, a method for manufacturing a wick structure 43 of a plate-type heat pipe 40 in accordance with a fourth embodiment of the disclosure differs only from the first embodiment in that a first engaging portion 451 of a mold 45 is curved, as is a first adhering portion 431 of the wick structure 43. Thickness of the first adhering portion 431 is increased from a center to distal ends. The central part of the first adhering portion 431 is thinner than other areas of the wick structure 43.

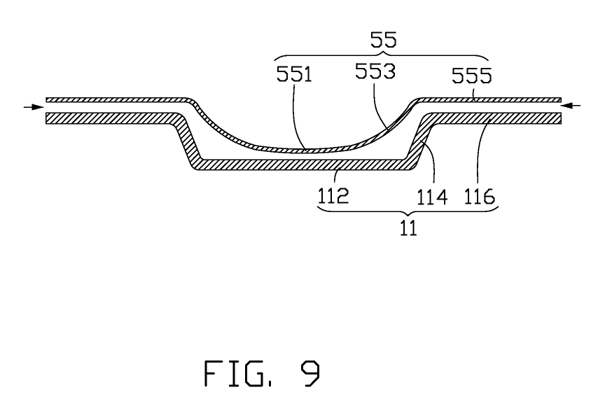

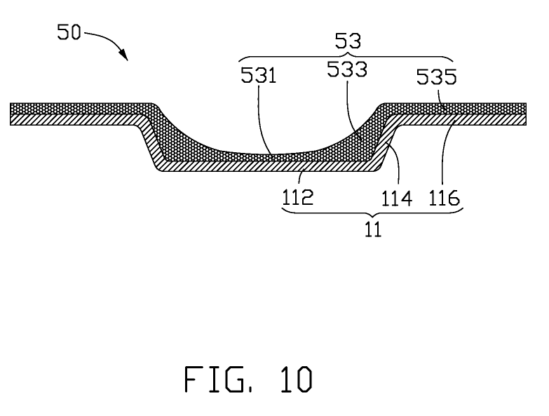

Referring to FIGS. 9 and 10, a method for manufacturing a wick structure 53 of a plate-type heat pipe 50 in accordance with a fifth embodiment of the disclosure differs only from the fourth embodiment in that a mold 55 includes a curved first engaging portion 551 corresponding to the heat absorbing plate 112, two curved second engaging portions 553 corresponding to the extending plates 114 of the base plate 11, and two horizontal third engaging portions 555 corresponding to the engaging plate 116 of the base plate 11. The two curved second engaging portions 553 smoothly extend from two lateral sides of the curved first engaging portion 551 whereby the first and second curved engaging portions cooperatively form an arced configuration. The metal powder between the first, second, and third engaging portions 551, 553, 555 of the mold 55 and corresponding to the heat absorbing plates 112, extending plates 114, and the engaging plates 116 forms a first adhering portion 531, two second adhering portions 533 and two third adhering portions 535, respectively. The first adhering portion 531 and the two second adhering portions 533 cooperatively present a curved top face. A thickness of the first adhering portion 531 is increased from a center to distal ends. The center of the first adhering portion 531 is thinner than other areas of the wick structure 53.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A method for manufacturing a wick structure of a plate-type heat pipe, comprising:
providing a base plate comprising an elongated heat absorbing plate adapted for contacting with a heat generating component and two extending plates angling upwardly from opposite ends thereof;
providing a quantity of metal powder;
providing a mold covering the base plate, comprising a first engaging portion corresponding to the heat absorbing plate of the base plate, and two second engaging portions angling upwardly from opposite ends of the first engaging portion and corresponding to the extending plates of the base plate, wherein the first and second engaging portions connect in series and the mold and the base plate mutually define a space therebetween;
filling the metal powder into the space;
heating the metal powder to obtain a wick structure comprising a first adhering portion securely fixed to a top surface of the heat absorbing plate of the base plate and two second adhering portions angling from opposite ends of the first adhering portion and securely fixed to top surfaces of the extending plates of the base plate;
wherein the first adhering portion of the wick structure has a thickness thinner than that of the second adhering portions.

2. The method for manufacturing a wick structure of a plate-type heat pipe as claimed in claim 1, wherein the first adhering portion of the wick structure is elongated.

3. The method for manufacturing a wick structure of a plate-type heat pipe as claimed in claim 1, wherein a center portion of the wick structure is elongated and the center portion of the first adhering portion is thinner than other portions of the first adhering portion, giving the first adhering portion a stepped configuration.

4. The method for manufacturing a wick structure of a plate-type heat pipe as claimed in claim 1, wherein the first adhering portion of the wick structure comprises two symmetrical trapezoid parts and thickness of the first adhering portion is increased from the center where the two trapezoid parts join toward opposite ends of the two trapezoid parts.

5. The method for manufacturing a wick structure of a plate-type heat pipe as claimed in claim 1, wherein a first adhering portion of the wick structure is curved and a thickness thereof is increased from a center to distal ends.

6. The method for manufacturing a wick structure of a plate-type heat pipe as claimed in claim 1, wherein the first and the second adhering portions of the wick structure are curved, and thickness of the curved configuration is increased from a center to distal ends.

7. The method for manufacturing a wick structure of a plate-type heat pipe as claimed in claim 1, wherein the base plate further comprises two engaging plates extending outwardly from ends of the extending plates respectively and facing apart, and the wick structure further comprises two third adhering portions securely fixed on top surfaces of the third engaging plates of the base plate.

8. The method for manufacturing a wick structure of a plate-type heat pipe as claimed in claim 7, wherein a thickness of the third adhering portion equals that of the second adhering portion of the wick structure.

9. The method for manufacturing a wick structure of a plate-type heat pipe as claimed in claim 1, wherein contours of the mold match those of the base plate.
